(19) United States
(12) Patent Application Publication
(10) Pub. No.: US 2016/0361815 A1
(43) Pub. Date: Dec. 15, 2016

(54) ROBOT AND ROBOT CONTROLLING METHOD

(71) Applicant: MITSUBISHI HEAVY INDUSTRIES, LTD., Tokyo (JP)

(72) Inventors: Natsuki MATSUNAMI, Tokyo (JP); Tomohiro TAMI, Tokyo (JP); Masato IEHARA, Tokyo (JP)

(21) Appl. No.: 15/117,573

(22) PCT Filed: Feb. 27, 2015
(86) PCT No.: PCT/JP2015/055829

§ 371 Date: Aug. 9, 2016

(30) Foreign Application Priority Data
Mar. 13, 2014 (JP) 2014-050150

(51) Int. Cl. B25J 9/16; G06N 3/00

(52) U.S. Cl. CPC B25J 9/163; G06N 3/008; G05B 2219/39289

(57) ABSTRACT

A robot (10) has a command predicting section (11) and a command determining section (12). The command predicting section (11) predicts the next second command based on the content of the first command issued from the remote control terminal (101). The command determining section (12) determines whether or not an operation result according to the second command should be transmitted to the remote control terminal (101), based on a comparison result between the second command and a third command issued from the remote control terminal (101) after the first command.

### TECHNICAL FIELD

The present invention relates to a robot, a method of controlling a robot and a control program of the robot, and especially, to a robot in which at least a part of operation is controlled by a remote control, a method of controlling the robot and a control program of the robot.

### BACKGROUND ART

There is a case that the controllability of a remote control robot is degraded depending on the state of a transmission path of a control command. For example, when the transmission path with a slow communication speed is used, it takes time until the operation result of the robot (e.g. a traveling result) is transmitted to the remote control terminal. Especially, in case of the remote control robot of a master-slave type, the robot operates based on a command value from a control side. On the control side, the operation result of the robot is referred to set a next command value. At this time, when the transmission of the command value and the operation result delays, the operation time using the robot increases greatly.

An example of the remote control robot is disclosed in JP H09-267283A (Patent Literature 1). The robot described in Patent Literature 1 interprets, when a command is received from a remote control terminal, the command to carry out the operation of the robot (for example, a sensing operation and a control of an actuator). In this case, the robot requests a command value to the remote control terminal and notifies status data showing the state of the robot to the remote control terminal. Also, the remote control terminal grasps the state of the robot based on the status data notified from the robot and transmits a next command value in response to the request. That is, the robot cannot execute a next operation until receiving the next command value from the remote control terminal. The next command cannot be issued from (a user of) the remote control terminal until the request of the command value and the notification of the status data are transmitted from the robot.

For example, when an operation such as “an operation of making a robot travel and pick up an image around the robot” is to be carried out, the user operating the remote control terminal is required to wait for a period from a time when a traveling command is issued to the robot to a time when traveling completion is notified from the robot. Also, the robot must wait for a period from when the traveling completion is notified to the remote control terminal to a time when a next pick-up command is issued from the remote control terminal. Moreover, the user operating the remote control terminal must wait until the picked-up image is transmitted from the robot after issuing the next pick-up command to the robot.

In this way, in a system in which a remote control robot carries out a plurality of operations in order, a predetermined waiting time becomes necessary for a period from the issuance of a command to confirmation of the operation completion or a period from the operation completion to reception of a next command. Especially, when a delay time of a communications line between the remote control terminal and the robot is large, the communication time predominates the operation time of the whole system.

### CITATION LIST

[Patent literature 1] JP H09-267283A

### SUMMARY OF THE INVENTION

The subject matter of the present invention is to provide a robot, a method of controlling the robot, and a control program of the robot, in which a work time of the remote control robot can be reduced.

The robot according to some embodiments has an operating section which operates in response to a command, a command predicting section and a command determining section. The command predicting section predicts a second command (a prediction command) next to a first command based on the content of the first command issued from the remote control terminal. The command determining section determines whether or not an operation result of the operating section responsive to the second command (the prediction command) should be transmitted to the remote control terminal, based on a comparison result between the second command (the prediction command) and a third command issued from the remote control terminal after the issuance of the first command. The robot according to some embodiments can carry out an operation which is to be carried out after a next remote command is transmitted, during a waiting period of a next remote command. Thus, the working time can be reduced greatly. Also, when the operation result based on the second command is not transmitted until the third command is issued, the wasteful data transmission can be removed.

The method of controlling a robot according to some embodiments is a method of controlling a robot which operates in response to a command. The method includes predicting a second command next to a first command based on the content of the first command issued from the remote control terminal, and determining whether or not an operation result of the operating section responsive to the second command (a prediction command) should be transmitted to the remote control terminal, based on a comparison result between the second command (the prediction command) and a third command issued from the remote control terminal after issuance of the first command.

A method of controlling a robot in some embodiments is realized in executing a program which is recorded on a storage medium, by a computer.

A robot according to some embodiments has an operating section which operates in response to a command, and computer which performs command prediction processing and determination result transmission determination processing. The command prediction processing contains processing of predicting the second command next to the first command based on the content of a first command issued from the remote control terminal. The determination result transmission determination processing contains processing of determining whether or not an operation result of the operating section in response to the second command should be transmitted to the remote control terminal, based on a comparison result between the second command and a third command issued from the remote control terminal after the issuance of the first command.

According to the present invention, the work time using the robot which is controlled by the remote control can be reduced.

### BRIEF DESCRIPTION OF THE DRAWINGS

The attached drawings are incorporated into this Description to help the description of embodiments. Note that the drawing should not be interpreted so as to limit the present invention to embodiments and examples shown in the drawings.

FIG. 1 is a diagram showing an example of the configuration of a remote control robot system according to some embodiments.

FIG. 2 is a diagram showing an example of point group data acquired by a robot according to some embodiments.

FIG. 3 is a diagram showing an example of the details of the configuration of the remote control robot system according to some embodiments.

FIG. 4 is a diagram showing an example of the configuration of prediction data according to some embodiments.

FIG. 5 is a flow chart showing an example of a method of controlling a robot according to some embodiments.

FIG. 6 is a flow chart showing another example of the method of controlling the robot according to some embodiments.

FIG. 7 is a flow chart showing another example of the method of controlling the robot according to some embodiments.

### DESCRIPTION OF THE EMBODIMENTS

Hereinafter, embodiments will be described with reference to the attached drawings. In the drawings, an identical or similar reference numeral is assigned to an identical or similarity component. In the next detailed description, many detailed specific items are disclosed for the purpose of description to provide the comprehensive understanding of the embodiments. However, it would be apparent that the embodiments can be executable without these detailed specific items.

### (Overview)

A robot in some embodiments predicts a next command based on a command from a remote control terminal, and carries out an operation according to the prediction command without waiting for the next command from the remote control terminal. Whether an operation result according to the predicted command should be transmitted to the remote control terminal is determined based on the next command from the remote control terminal. For example, when a prediction command value and a command value from the remote control terminal are coincident with each other, the robot transmits the operation result according to the prediction command. In case of the non-coincidence, the robot returns to a state before the operation according to the prediction command.

### [Configuration]

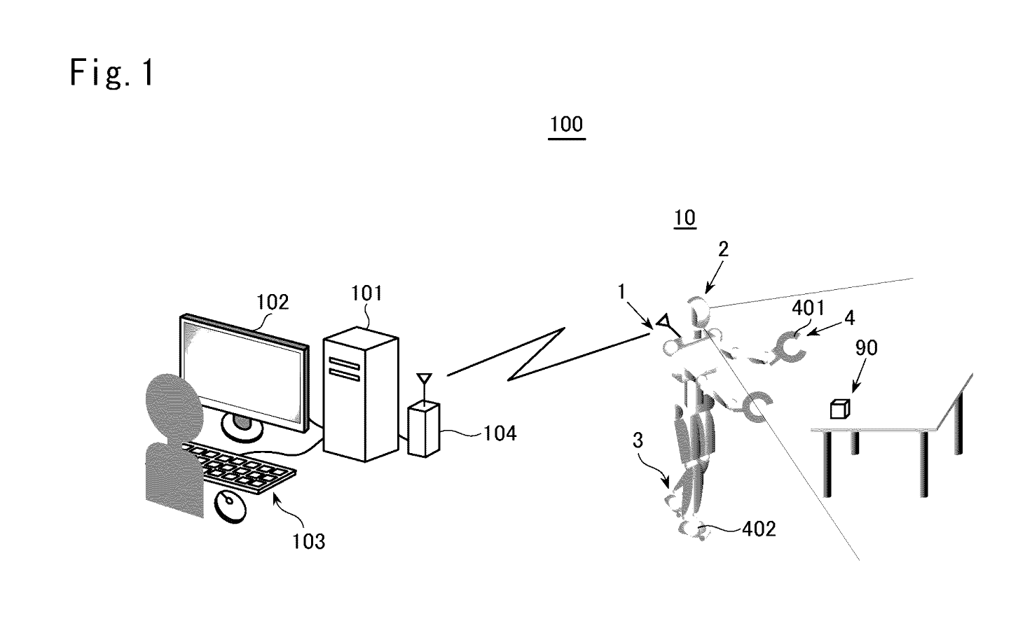

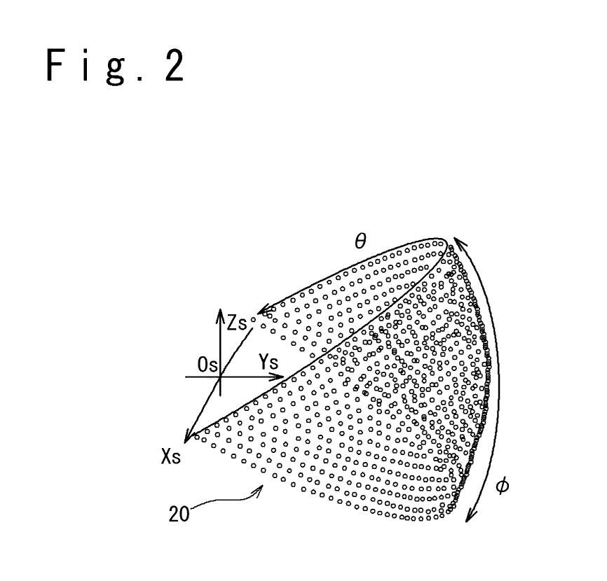

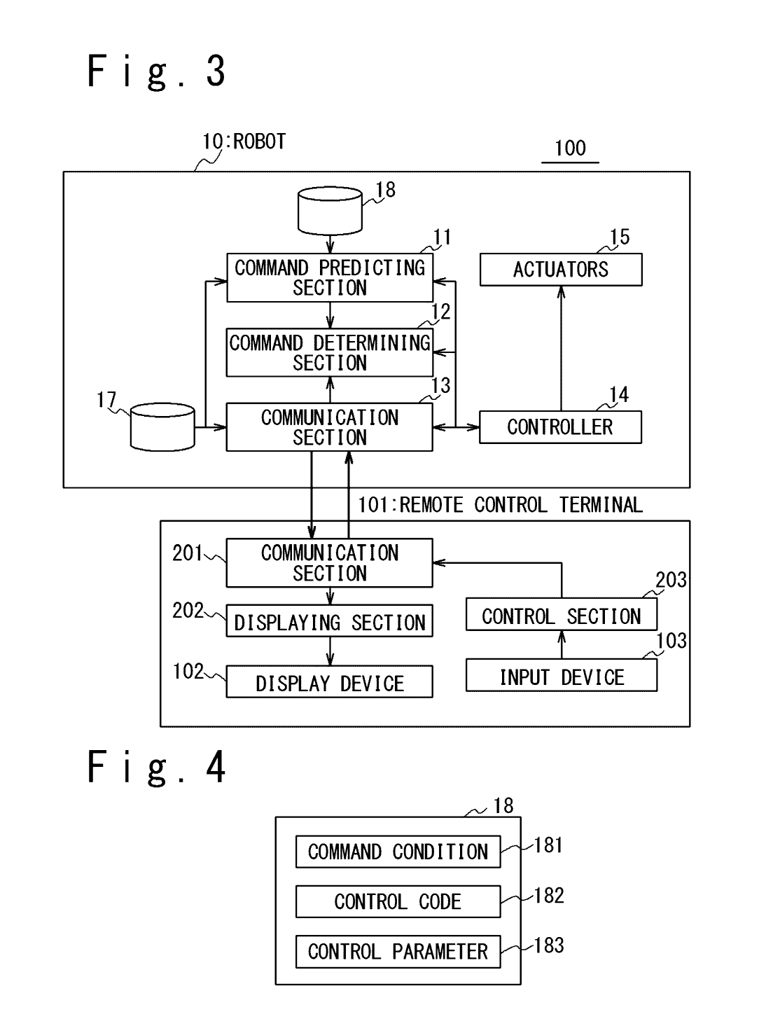

Referring to FIG. 1 to FIG. 3, an example of the configuration of a remote control robot system 100 will be described. FIG. 1 is a diagram showing an example of the configuration of the remote control robot system 100. FIG. 2 is a diagram showing an example of point group data acquired by the robot. FIG. 3 is a diagram showing an example of the details of the configuration of the remote control robot system 100.

Referring to FIG. 1, the remote control robot system 100 includes a remote control terminal 101 and a robot 10. In the robot 10, a traveling motion or a motion operation of an arm section 4 (manipulator) to be mentioned later is controlled in response to a command (a control signal) from the remote control terminal 101. For example, in response to a command from the remote control terminal 101, the robot 10 carries out an operation of “travelling to the neighborhood of a target 90, picking up the neighborhood of target 90 and producing a topographic map”. At this time, the robot 10 travels to the neighborhood of the target 90, and transmits point group data 20 picked up with an image sensor 2 (e.g. a three-dimensional (3D) sensor, i.e. a sensor for acquiring 3D shape data) to the remote control terminal 101. The user uses the remote control terminal 101 to command the robot 10 to do the next operation, while confirming a surface shape image around the robot 10 produced based on the point group data 20.

Hereinafter, with reference to FIG. 1 to FIG. 3, the details of the configuration of the remote control robot system 100 will be described.

The remote control terminal 101 is connected with an output device 102, an input device 103, and a transmission unit 104. The remote control terminal 101 is exemplified by a computer system and is composed of a CPU and a storage device (which are not shown). The remote control terminal 101 controls the operation of the robot 10, and produces an image of the surface shape of a measurement target based on the point group data 20 transmitted from the robot 10, and visibly outputs the image to the output device 102. The details of the configuration of the remote control terminal 101 will be described later. The output device 102 is exemplified by a monitor and a printer, and visibly outputs the image outputted from the remote control terminal 101. The input device 103 is exemplified by a keyboard, a touch-panel, a mouse, a joystick and so on, and is an interface unit which inputs various data to the remote control terminal 101 through an operation by the user. The transmission unit 104 is a communication interface unit which controls the transmission of data and signals between the remote control terminal 101 and the robot 10 (a transmission unit 1). In detail, the transmission unit 104 builds a transmission path with the transmission unit 1 loaded in the robot 10 by either of a radio line or a wired line or both lines, and controls a data transmission between the remote control terminal 101 and the robot 10.

It should be noted that the remote control terminal 101, the output device 102, the input device 103, and the transmission unit 104 may be provided as individual units as shown in FIG. 1. However, all the units (or elements) may be provided as a unitary body, or at least two of all the units (or the elements) may be provided as a unitary body. For example, a unit formed by integrating the output device 102 and the input device 103 can be realized as a touch-panel. Also, a device formed by integrating the remote control terminal 101 and the transmission unit 104 can be realized by a computer system with a communication function. Moreover, a mobile phone (called smartphone) of a touch-panel type, a PDA (Personal Digital Assistants) with a communication function and so on are exemplified as the form in which all of the remote control terminal 101, the output devices 102, the input devices 103, and the transmission unit 104 are integrated.

The robot 10 includes the transmission unit 1, a 3D sensor 2, a leg section 3, and an arm section 4. In this embodiment, the 3D sensor 2, or an actuator 15 (not shown in FIG. 1) which drives the leg section 3, the arm section 4 and so on, functions as an operating section which operates based on a command. The robot 10 transmits its own position data and attitude data of the leg section 3, the arm section 4 and so on to the remote control terminal 101 through the transmission unit 1 periodically or or at a predetermined timing. Also, the robot 10 transmits point group data acquired through the measurement using the 3D sensor 2, to the remote control terminal 101. Note that the actuator 15, the 3D sensor 2 (may be an image sensor) and so on configures the operating section which operates based on a command to be described later (a remote command, a prediction command, a restoration command and so on).

The transmission unit 1 is an interface unit which controls the data (signal) transmission between the robot 10 and the remote control terminal 101. In detail, the transmission unit 1 builds a transmission path with the transmission unit 104 connected with the remote control terminal 101 by either of a radio line or a wired line or both lines, and controls the data transmission between the robot 10 and the remote control terminal 101.

The 3D sensor 2 is exemplified by a laser scanner and a stereo camera, and acquires the 3D position coordinates on the surface of a measurement target around the robot 10 as point group data 20 (called a point cloud). The laser scanner which can be used as the 3D sensor 2 measures the point group data 20 by either of a trigonometric method, a time-of-flight method, or a phase difference method (phase shift method). In the robot 10 of the present embodiment, the 3D sensor 2 is loaded as a unit which observes a situation around the robot 10. However, the present invention is not limited to this, and an image pickup device exemplified by a CCD camera may be loaded.

Referring to FIG. 2, an example of a measurement range (scanning range) of the point group data 20 by the 3D sensor 2 will be described. Here, a measurement position of the 3D sensor 2 (e.g. an installation position) is supposed to be set as an origin point O and the coordinate system for the measured point group data 20 is supposed to have (Xs, Ys, Zs). The 3D sensor 2 scans a laser in a range of an azimuth angle θ and an elevation angle φ to have the origin point O at a center as an irradiation angle and measures (acquires) 3D coordinates of each point on the surface of the measurement target as the point group data 20 based on the reflection light from the measurement target in this range. The robot 10 travels by using the leg section 3 and measures the point group data 20 in each of a plurality of positions (in other words, a plurality of positions of the 3D sensor), and acquires the point group data 20 in a desired range by carrying out matching composition of the measured point group data 20.

Here, the robot 10 may be provided with a CCD camera to acquire color data (RGB) so as to improve visibility of the landform around the robot and the shape of the target, in addition to the 3D sensor 2. In this case, the point group data 20 and the color data may be synthesized (color matching). However, in order to reduce a data transmission quantity to the remote control terminal 101, or, to reduce a computation quantity in the robot 10, the point group data 20 and the color data may be transmitted from the robot to the remote control terminal 101 at different timings and are subjected to the color matching in the remote control terminal 101.

Referring to FIG. 1, the leg section 3 is driven by the actuator 15 to be described later, and is traveling means for moving the robot 10 to an optional position. In the present embodiment, a leg having a joint and a link will be described as an example of the leg section 3. However, a rotating body (e.g. a wheel) which is rotated by a motor and an engine may be provided for the robot 10 as the leg section 3. The number of legs, the shape of the leg, and the number of joints (the number of links) in the leg section 3 are not limited to the number and shape shown in the drawings, and they can be optionally set. The arm section 4 is driven by the actuator 15 to be described later, and is exemplified by a manipulator (called an arm) having joints, links and an end effector 401. The end effector 401 is provided for, for example, the tip of the arm section 4, and preferably has a mechanism which gives the target a physical operation (a dynamic operation, an electromagnetic operation, a thermodynamics operation). Specifically, the end effector 401 may have a mechanism for holding, painting or welding the target. Alternatively, or additionally, the end effector 401 may be provided with an electromagnetic sensor, various measurement equipments and so on. In an example shown in FIG. 1, a robot hand is provided for the arm section 4 as end effector 401 to hold (handle) the target. The number of arms, the shape of the arm, and the number of joints (the number of links) in the arm section 4, and the configuration of the end effector 401 are not limited to those shown in FIG. 1 and they may be optionally set.

Referring to FIG. 3, the details of the configuration of the remote control terminal 101 and the robot 10 according to the present invention will be described. In the remote control terminal 101, by a CPU executing a software program having been stored in a storage device (not shown), each function of a communication section 201, a displaying section 202 and a control section 203 is realized. Each function of the communication section 201, the displaying section 202 and the control section 203 may be realized by a hardware configuration or a cooperation of the software configuration and the hardware configuration.

The communication section 201 controls the transmission unit 104 shown in FIG. 1 and controls communication with the transmission unit 1 in the robot 10. In detail, the communication section 201 transmits a control signal from the control section 203 to the transmission unit 1 of the robot 10 through the transmission unit 104, or, outputs (a signal corresponding to) the point group data 20 transmitted from the robot 10 to the displaying section 202. The displaying section 202 generates image data to display on the output device 102. In detail, the displaying section 202 uses the point group data 20 supplied from the communication section 201 to produce and output the image data to the output device 102 so as to display the surface shape of the measurement target. For example, the displaying section 202 calculates the image data to display the surface shape of the measurement target through processing to the point group data 20 such as edge detection, smoothing by noise removal, and normal extraction. The control section 203 generates a control signal according to an input signal from the input device 103 to output to the communication section 201. The robot 10 controls the operations of the leg section 3, the arm section 4 and so on or the acquisition of the point group data 20 and so on, for example, according to the control signal outputted from the control section 203.

The robot 10 includes a computer system (not shown) (for example, the computer system contains a CPU, a storage device and so on). In the robot 10, by the CPU executing the software program stored in the storage device (not shown), each function of a the command predicting section 11, a command determining section 12, a communication section 13 and a controller 14 is implemented. Each function of the command predicting section 11, the command determining section 12, the communication section 13 and the controller 14 may be realized by only the hardware configuration or the cooperation of the software configuration and the hardware configuration. Because the computer system (CPU) executes the above-mentioned program, next command prediction processing, command determination processing, determination result transmission determination processing and so on are realized.

The operation result data 17 and prediction data (for example, basis data to generate a prediction command) 18 are recorded in a storage device of the robot 10. The operation result data 17 shows the operation result obtained by executing the command by the robot 10. For example, when the command is a measurement command (an acquisition command) of the point group data, the point group data 20 measured by the 3D sensor 2 in response to the command, the measurement position coordinates of the point group data 20 (for example, a position coordinates of the 3D sensor or an orientation of the 3D sensor), a measurement range (for example, a range of azimuth angle θ and elevation angle φ) and so on are recorded as the operation result data 17. Or, when the command is a motion control command for the leg section 3, the arm section 4, and so on, the attitude data of the robot 10 after the operation (coordinate data of a link of the leg section 3 or the arm section 4, rotation angle data of a joint and so on), position coordinates of the robot 10 and so on are recorded as the operation result data 17. The recording of the operation result data 17 may be carried out in a predetermined period or in response to a change of the attitude on the way of the operation in addition to timing when the operation according to the command is completed.

The prediction data 18 includes a condition when the command predicting section 11 to be described later issues a prediction command, and data of the prediction command issued according to the condition. FIG. 4 is a diagram showing an example of the configuration of prediction data 18. Referring to FIG. 4, the prediction data 18 contains a command condition 181, a control code 182, and a control parameter 183, which are related to each other.

The command condition 181 shows a condition to issue the prediction command. The robot 10 predicts the next command based on the command from the remote control terminal 101 (hereinafter, to be referred to as a remote command). Therefore, it is desirable that the command condition 181 includes a command content of the remote command and a command value (a target value). For example, the command content of the remote command, a criterion to the command value of the remote command and so on are set as the command condition 181. Specifically, as the command condition 181, criteria to the attitude of the robot 10 (link coordinates of the leg section 3 or arm section 4, a rotation angle of a joint, or threshold values or a range of them) are set. Or, a criterion to the traveling distance of the robot 10 is set as the command condition 181. Moreover, the measurement command of the point group data is set as the command condition 181.

The control code 182 contains a command code that prescribes a command content of the prediction command. For example, a command code that commands measurement of the point group data 20 is set as the control code 182. Or, a command code to drive an actuator 15 is set as control code 182.

The control parameter 183 contains a constraint when the prediction command is executed. For example, a command value of the prediction command (for example, a target value of the actuator 15) and a measurement condition of the sensor (for example, a measurement direction and a measurement range of the point group data 20) are set as the control parameter 183.

The command predicting section 11 predicts a command next to a remote command based on the remote command and the prediction data 18. In detail, when the command content and the command value of the remote command supplied through the communication section 13 meets the command condition 181 of the prediction data 18, the command predicting section 11 issues as the prediction command, a command corresponding to the control code 182 related to the command condition 181 and corresponding to the constraint which is prescribed in the control parameter 183. However, the prediction command is issued after execution of the remote command.

For example, the command predicting section 11 issues s measurement command of the point group data 20 as the prediction command when the remote command has been issued to drive the actuator 15, and the attitude of the robot 10 becomes the state that complies with the command condition 181. Or, the command predicting section 11 issues the measurement command of the point group data 20 as the prediction command, when the remote command has been issued to travel the robot 10, and the traveling distance is equal to or longer than a threshold value set to the command condition 181. Moreover, the command predicting section 11 issues the prediction command to travel the robot 10 to a predetermined position (for example, a predetermined next position to measure the point group data), when the remote command has been issued to measure the point group data 20.

Here, the processing of predicting the next command in the command predicting section 11 (command prediction processing) may be carried out by referring to the remote command or may be carried out based on the execution result of the remote command. When the command prediction processing is carried out based on the execution result of the remote command, the command predicting section 11 can confirm the content and a command value of the remote command based on the operation result data 17.

The command determining section 12 carries out the command determination processing, i.e. processing of determining whether the remote command received by the robot after the prediction command is issued, and the prediction command are coincident with each other in a predetermined range. Also, the command determining section 12 carries out the determination result transmission determination processing, i.e. processing of determining of whether or not the determination result should be transmitted to the remote control terminal. In the determination result transmission determination processing, it is determined whether or not the operation result data 17 according to the prediction command should be transmitted to the remote control terminal 101 based on the determination result acquired in the command determination processing. Note that in the command determination processing, when the content and a command value of the remote command are coincident with the content and a command value of the prediction command in a range of a predetermined error, the coincidence is determined. For example, when a traveling distance (the command value) coincides with the command value of the prediction command within an error of the coincidence judgment in the remote command to travel the robot 10, the coincidence is determined.

Also, when the remote command and the prediction command do not coincide in the predetermined range, the command determining section 12 determines whether or not the robot 10 should be restored to a previous state according to the execution situation of the prediction command. Moreover, when the state of the robot 10 should be restored to a state before execution of the prediction command, the command determining section 12 issues a command for the state restoration (hereinafter, referred to as a restoration command) (in other words, the computer of the robot carries out restoration command issuance processing). It is desirable that the command determining section 12 grasps the current state and the state before the execution of the prediction command based on the operation result data 17, and generates the restoration command which contains a command value based on the state before the execution of the prediction command (for example, a command value to return to the state before the execution of the prediction command). Also, when the prediction command is the acquisition of the point group data, it is desirable that the command determining section 12 issues the restoration command which deletes the acquired data, in order to restore the state before the execution of the prediction command. Note that when the execution of the prediction command has not completed, the robot may interrupt the execution of the prediction command and execute an operation which is based on the restoration command.

The controller 14 controls the operation of the actuator 15 in response to a remote command based on a control signal supplied from the remote control terminal 101 through the communication section 13, a prediction command from the command predicting section 11, or a restoration command from the command determining section 12. In detail, the controller 14 controls the actuator 15 under a decomposition motion control based on a command value (e.g. data of a target position, a target angle, and a target speed) to move the leg section 3, the arm section 4 and so on to desired positions.

The actuator 15 is exemplified by a servo motor, a power cylinder, a linear actuator, a rubber actuator and so on, and controls mechanical behaviors of the leg section 3, the arm section 4 and so on in response to a control command signal from the controller 14. The actuator 15 may drive the leg section 3, the arm section 4 and so on indirectly or directly. That is, the actuator 15 may be provided separately from the leg section 3 or the arm section 4, or may be provided as a part of the leg section 3, the arm section 4 and so on (e.g. a joint section). Also, when the leg section 3 is a rotating body exemplified by a wheel, a motor or an engine may be used as the actuator 15.

In the above-mentioned configuration, the robot 10 becomes possible to predict a next command and to automatically execute it, without waiting for the next command from the remote control terminal 101. For example, the robot 10 can detect the point group data in response to the prediction command after traveling by a given distance in response to the remote command. Or, the robot 10 detects the point group data of a region containing the end effector 401 or the end effector 402 in response to the prediction command, when moving the head loaded with the 3D sensor 2 to a direction of the end effector 401 or the end effector 402 in response to the remote command.

### (Robot Control Method)

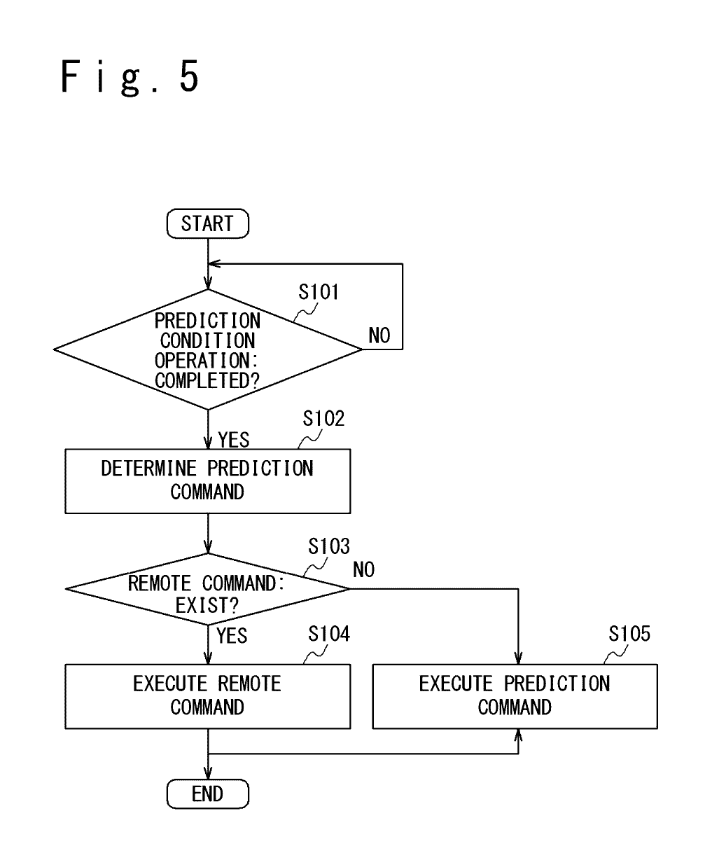

Next, with reference to FIG. 5 to FIG. 7, a method of controlling the robot 10 in some embodiments will be described in detail.

FIG. 5 is a flow chart showing an example of the operation of the robot 10 when receiving a remote command by the robot 10 before the prediction command is executed (issued). Referring to FIG. 5, when the operation responsive to the remote command (a first command) completes, the command predicting section 11 determines whether or not the remote command complies with a command condition 181 (Step S101). In other words, a computer of the robot (the command predicting section) carries out compliance determination processing of determining whether or not the remote command complies with the command condition 181. When the remote command does not comply with all the command conditions 181 registered as prediction data 18, any prediction command is not issued and the robot 10 awaits a remote command (Step S101: No). On the other hand, when any of the registered command conditions 181 complies with the remote command, the prediction command (a second command) which is based on a control code 182 corresponding to the command condition 181 and a control parameter 183 is determined (Step S101: Yes; Step S102). Step S102 contains processing of predicting the second command based on the first command issued from the remote control terminal, and determining the predicted second command as the prediction command. When the next remote command (a third command) is issued before the issuance of the determined prediction command, the next remote command (the third command) is executed with a priority (Step S103: Yes; Step S104). At this time, it is desirable that the prediction command before the issuance is abandoned.

On the other hand, when any remote command is not issued for a predetermined period after the determining of the prediction command, the prediction command is issued so that an operation responsive to the prediction command is carried out (Step S103: No; Step S105). In other words, the computer of the robot transmits a signal corresponding to the prediction command to the controller 14, and the controller 14 drives an operating section (the image sensor, the actuator and so on) in response to the signal. Note that a predetermined extension period until the prediction command is issued after the determination of the prediction command can be set optionally. Thus, when the determination of the remote control terminal 101 is earlier and the remote command is issued during the extension period, a wasteful operation depending on the prediction command can be excluded. Also, the prediction command may be issued at once after the determination of the prediction command. For example, when only the remote command having a long execution time or a long determination time for a remote control is set as the command condition 181, it is desirable that a prediction command is executed at once after the execution of the remote command.

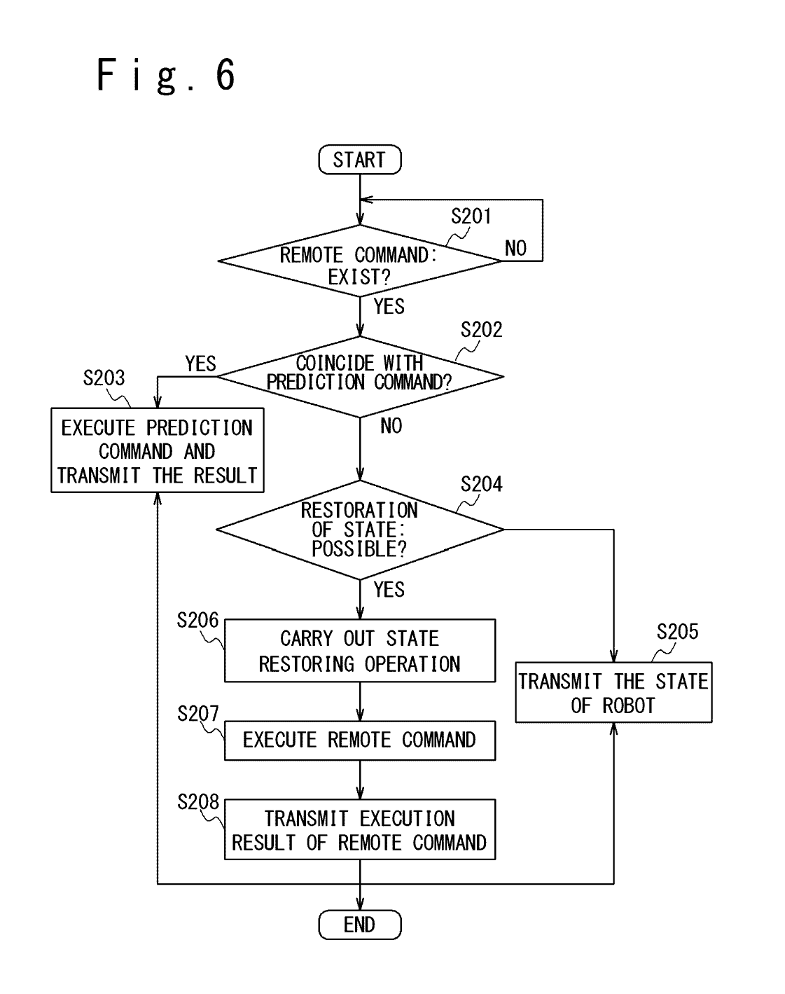

FIG. 6 is a flow chart showing an example of the operation of the robot 10 when receiving the next remote command after the operation according to the prediction command completes. Referring to FIG. 6, when receiving the next remote command (a third command) after execution of the prediction command (the second command), the command determining section 12 determines whether the prediction command and the remote command coincide in a predetermined range (Step S201: Yes; Step S202). In other words, the computer of the robot (the command determining section 12) carries out processing (the command determination processing) of determining whether the prediction command and the remote command (the third command) received by the robot after issuance of the prediction command coincide in the predetermined range. In this case, whether or not the command contents (the operation targets) of the prediction command and the remote command coincide in a predetermined range is determined or whether or not the command values (e.g. a target value, the measuring range, and the measurement resolution) coincide in a predetermined range is determined. For example, when the operation targets of the prediction command and the remote command coincide with each other, and when the command values of the prediction command and the remote command coincide with each other in a predetermined error range, the prediction command and the remote command are determined to coincide with each other. When the prediction command and the remote command are determined to coincide in the predetermined range, the operation result according to the prediction command is transmitted to the remote control terminal 101 (Step S202: Yes; Step S203). Thus, the user who operates the remote control terminal 101 can know the next operation result (the operation result of a next operation following the operation which is based on the remote command) which has been automatically executed in the robot 10.

On the other hand, when the prediction command and the remote command do not coincide, whether or not the state of the robot 10 can be restored to a state before the execution of the prediction command is determined (Step S202: No, Step S204). In other words, the computer of the robot (e.g. the command determining section 12) carries out restoration possibility determination processing of determining whether or not the state of the robot 10 can be restored to a state before the execution of the prediction command. For example, when the prediction command is a command of controlling the operation of the actuator 15, the command determining section 12 calculates a command value corresponding to restoration to the state of the robot 10 before the execution of the prediction command from the state of the robot 10 after the execution of the prediction command (for example, an attitude of the robot or position coordinates of the robot), and generates a restoration command having a command value as the target value. Or, when the prediction command is measurement of the point group data 20, the command determining section 12 generates a command to abandon the point group data 20 measured based on the prediction command, as the restoration command. When the restoration command cannot be generated, the command determining section 12 determines state restoration to be impossible. For example, when a walking plan is specified in the prediction command such that the robot 10 travels to a predetermined position, there is a case where the walking plan cannot be generated to restore the robot to the original position. In such a case, a state is determined to be impossible.

When the restoration of the state is impossible at step S204, the robot 10 transmits the current state of the robot 10 (for example, the attitude of the robot, the position coordinates of the robot and so on) to the remote control terminal 101 (Step S204: No; Step S205). Thus, the user who operates the remote control terminal 101 can know the next operation result (the operation result of the next operation following the operation which is based on the remote command) which has been automatically executed in the robot 10. Desirably, the robot 10 which has transmitted the current state discards the remote command (the third command) received at step S201 and awaits a next new remote command.

When it is possible to restore the state at step S204, the robot 10 carries out the restoration operation according to the state restoration command (Step S206). Also, the robot 10 executes the remote command (the third command) received at step 5201 after the state restoration (Step S207). The execution result of the remote command is transmitted to the remote control terminal 101 regularly or promptly after the execution of the remote command completes (Step S208).

In some embodiments, the robot 10 can carry out the operation to be carried out after the next remote command is transmitted, during the waiting period of the next remote command. Therefore, the time for the whole work can be substantially reduced. Also, when the next remote command does not coincide with the prediction command (for example, when the state of the robot is restored to the state before the conduct of the operation which is based on the prediction command), the robot 10 in some embodiments can avoid the unnecessary data communication because the result of the prediction command is not transmitted to the remote control terminal 101. Thus, the unnecessary communication processing, the unnecessary communication time and so on can be avoided when the prediction fails while predicting the next operation. Moreover, when the operation different from the operation corresponding to the next remote command is predicted, the state of the robot can be restored if the state of the robot 10 can be restored. Therefore, the next operation can be carried out without receiving a command from the remote control terminal 101 once again. Also, when the state of the robot cannot be restored, the user can grasp the current situation even if the prediction fails, because the current state is transmitted to the remote control terminal 101.

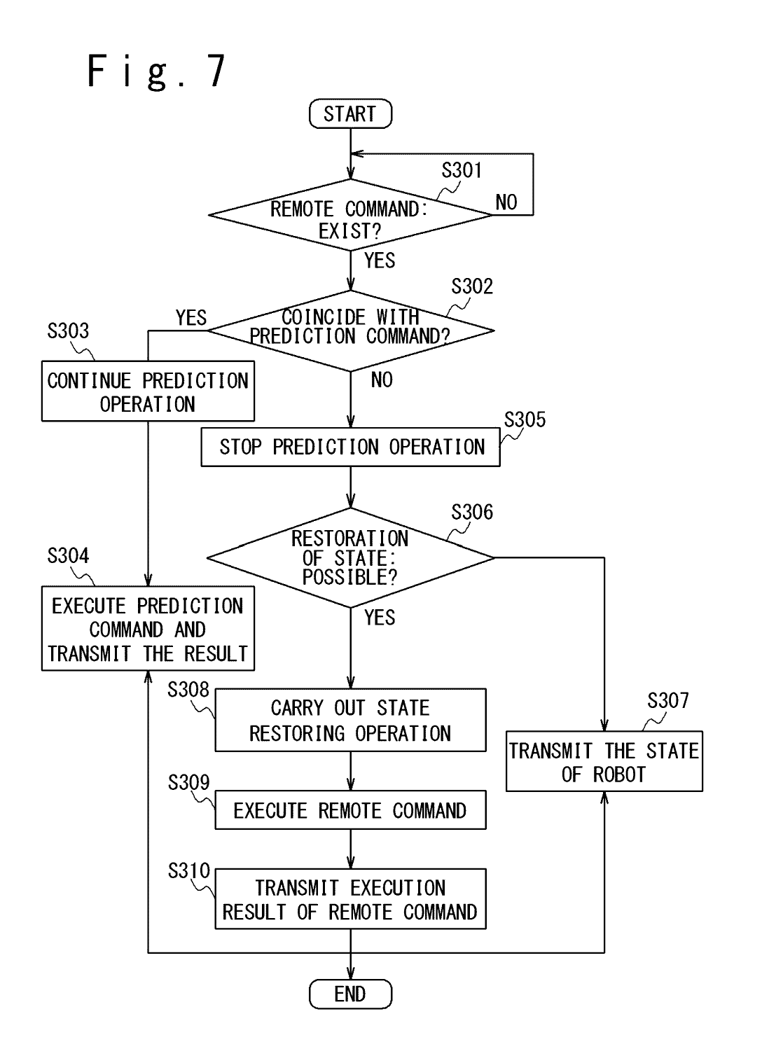

FIG. 7 is a flow chart showing an example of the operation of the robot 10 when receiving the next remote command while carrying out an operation according to the prediction command by the robot 10. Referring to FIG. 7, when receiving the next remote command (the third command) after the execution of the prediction command (the second command), the command determining section 12 determines whether the prediction command and the next remote command coincide in a predetermined range (Step S301: Yes; Step S302). In this case, whether the command contents (the operation targets) of the prediction command and the next remote command coincide with each other or whether the command values of them (e.g. the target values, the measuring ranges, the measurement resolutions) coincide in a predetermined range is determined. For example, when the operation targets of the prediction command and the next remote command coincide, and when the command values of them coincide in a predetermined error range, the prediction command and the next remote command are determined to coincide. When the prediction command and the next remote command are determined to coincide in the predetermined range, the robot 10 continues the prediction operation (in other words, the computer of the robot issues a command to an operating section to continue the prediction operation processing), transmits the operation result according to the prediction command to the remote control terminal 101 (Step S302: Yes; Steps S303, S304). Thus, the user who operates the remote control terminal 101 can know the next operation result (the operation result of the next operation following the operation which is based on the remote command) which has been automatically carried out in the robot 10.

On the other hand, when the prediction command and the next remote command do not coincide, the robot 10 stop the prediction operation (in other words, the computer of the robot controls through the controller 14 to carry out prediction operation stop processing of stopping the prediction operation), and determines whether or not the state of the robot 10 can be restored to a state before the execution of the prediction command (Step S302: No; Steps S305, S306). Hereinafter, the state restoration determination processing (step S306), the state transmission processing of the robot according to the result of the state restoration determination (step S307), the conduct processing of the state restoration operation (step S308), the execution processing of the next remote command (the third command) (step S309), the transmission processing of the execution result (step S310) are same as those of the above-mentioned steps S204 to 5208, and therefore, the description is omitted.

The robot in some embodiments continues to execute the prediction command when the next remote command which coincides with the prediction command is issued during the execution of the prediction command. Therefore, the time from the issuance of the remote command to the completion of the operation according to the remote command can be shortened. Also, when the prediction command in execution and the next remote command do not coincide, the operation is stopped without waiting for the completion of the operation according to the prediction command. Therefore, the time for the wasteful operation can be excluded.

As the prediction command, it is desirable that various control parameters 183 are set according to the content of the remote command (command condition 181). Hereinafter, a specific example of the remote command, the prediction command to be executed next to the remote command, and the control parameter 183 at that time are shown.

The robot 10 must confirm the detailed landform after walking by a short distance. Therefore, when the immediately previous remote command instructs to travel (walk) by a predetermined distance or below, it is desirable that the prediction command is issued to acquire the point group data in a resolution higher than a predetermined resolution. On the other hand, when the robot 10 walks for a long distance, the general landform must be early grasped. Therefore, when the immediately previous remote command instructs to travel (walk) for a predetermined distance or above, it is desirable that the prediction command is issued to acquire the point group data in a resolution lower than a predetermined resolution.

Also, a request to grasp a state near the foot (the ground surface) of the robot 10 precisely is strong. Therefore, when the immediately previous remote command instructs to lower the head loaded with the 3D sensor 2, it is desirable that the prediction command is issued to acquire the point group data in a resolution higher than the predetermined resolution. On the other hand, when the head loaded with the 3D sensor 2 is turned to a front direction, the whole space must often be grasped. Therefore, when the immediately previous remote command instructs to turn the head loaded with the 3D sensor 2 to the front direction, it is desirable that the prediction command is issued to acquire the point group data in a resolution lower than the predetermined resolution.

Moreover, when a target 90 (referring to FIG. 1, if necessary) should be held with the end effector 401, there is a strong request to grasp a situation of the target 90 and its periphery. Therefore, when the immediately previous remote command instructs to hold by the end effector 401, it is desirable that the prediction command is issued such that the point group data is acquired in a resolution higher than the predetermined resolution in an area within a predetermined distance from the end effector 401 and in a resolution lower than the predetermined resolution in the other area.

In the above, the embodiments of the present invention have been described. However, a specific configuration is not limited to the above embodiments, and a modification is contained in the present invention if the modification does not deviate from the features of the present invention. The embodiment and the example can be combined with another embodiment and another example in a range of no contradiction.

The present application is based on Japanese Patent Application No. JP 2014-50150 filed on Mar. 13, 2014 and claims a priority of the application. The disclosure thereof is incorporated herein by reference.

1. A robot comprising:
an operating section configured to operate in response to a command;
a storage device which stores a program; and
a processing unit which executes the program to implement:
a command predicting section configured to predict a second command next to a first command based on a content of the first command issued from a remote control terminal; and
a command determining section configured to determine whether or not an operation result of the operating section responsive to the second command should be transmitted to the remote control terminal based on a result of comparison between the second command and a third command issued from the remote control terminal after the issuance of the first command.

2. The robot according to claim 1, wherein, when the third command and the second command coincide in a predetermined range, the command determining section determines to transmit the operation result to the remote control terminal.

3. The robot which according to claim 1, wherein, when the third command received from the remote control terminal during the operation responsive to the second command and the second command coincide in the predetermined range, the operating section continues the operation responsive to the second command.

4. The robot according to claim 1, wherein, when the third command and the second command do not coincide in the predetermined range, the operating section restores a state of the robot to a state previous to the operation responsive to the second command.

5. The robot according to claim 4, wherein, when the third command and the second command do not coincide in the predetermined range and it is impossible to restore the state of the robot to the state previous to the operation responsive to the second command, the operation result responsive to the second command is transmitted to the remote control terminal.

6. The robot according to claim 1, wherein, when the second command and the third command received from the remote control terminal during the operation responsive to the second command do not coincide in the predetermined range, the operating section stops the operation responsive to the second command.

7. The robot according to claim 1, wherein the operating section comprises a three-dimensional sensor which acquires point group data including three dimensional data as the operation responsive to the second command, and wherein the operation result comprises the point group data acquired by the three dimensional sensor.

8. The robot according to claim 1, wherein the operating section comprises an actuator which drives a part of the robot in response to the second command, and
wherein the operation result comprises a command value of the second command.

9. A method of controlling a robot, which operates responsive to a command, comprising:
predicting a second command next to a first command based on a content of the first command issued from a remote control terminal; and
determining whether or not an operation result of an operating section responsive to the second command is transmitted to the remote control terminal, based on a result of comparison between the second command and a third command issued from the remote control terminal after issuance of the first command.

10. The method of controlling a robot according to claim 9, wherein the determining comprising determining that the operation result is transmitted to the remote control terminal, when the third command and the second command coincide in the predetermined range.

11. The method of controlling a robot according to claim 9, further comprising:
continuing the operation of the operating section responsive to the second command, when the second command and the third command received from the remote control terminal during the operation of the operating section responsive to the second command coincide in the predetermined range.

12. The method of controlling a robot according to claim 9, further comprising:
restoring a state of the robot to a state before the operation responsive to the second command is carried out, when the second command and the third command do not coincide in the predetermined range.

13. The method of controlling a robot according to claim 12, further comprising:
transmitting the operation result responsive to the second command to the remote control terminal, when the third command and the second command do not coincide in the predetermined range, and it is impossible to restore the state of the robot to the state before the operation responsive to the second command is carried out.

14. The method of controlling a robot according to claim 9, further comprising:
stopping the operation of the operating section responsive to the second command, when the second command and the third command received from the remote control terminal during the operation of the operating section responsive to the second command do not coincide in the predetermined range.

15. The method of controlling a robot according to claim 9, wherein the operation of the operating section responsive to the second command comprises an operation of acquiring the point group data having three-dimensional coordinate data, and
wherein the operation result comprises the acquired point group data.

16. The method of controlling a robot according to claim 9, wherein the operation responsive to the second command comprises driving the actuator as the operating section, and
wherein the operation result comprises a command value of the second command.

17. A non-transitory recording medium which stores a program which is executed by a processing unit to implement:
a command predicting section configured to predict a second command next to a first command based on a content of the first command issued from a remote control terminal; and
a command determining section configured to determine whether or not an operation result of the operating section responsive to the second command should be transmitted to the remote control terminal based on a result of comparison between the second command and a third command issued from the remote control terminal after the issuance of the first command.

18. A robot comprising:
an operating section which operates in response to a command;
a storage device which stores a program; and
a processing unit which executes the program to implement:
a command prediction processing section predicting a second command after a first command based on a content of the first command issued from a remote control terminal; and
a determination result transmission determination processing section determining whether or not the operation result of the operating section responsive to the second command should be transmitted to the remote control terminal, based on a comparison result between the second command and a third command issued from the remote control terminal after the issuance of the first command.
